(19) United States
(12) Patent Application Publication
(10) Pub. No.: US 2024/0362495 A1
(43) Pub. Date: Oct. 31, 2024

(54) EXECUTION OF A MACHINE LEARNING MODEL BY A SYSTEM OF RESOURCE NODES

(71) Applicant: TELEFONAKTIEBOLAGET LM ERICSSON (PUBL), STOCKHOLM (SE)

(72) Inventor: Fereydoun Farrahi Moghaddam, Coquitlam (CA)

(21) Appl. No.: 18/579,475

(22) PCT Filed: Jul. 15, 2021
(86) PCT No.: PCT/IB2021/056390

§ 371 Date: Jan. 15, 2024

(51) Int. Cl. G06N 3/098; G06N 3/082

(52) U.S. Cl. CPC G06N 3/098; G06N 3/082

(57) ABSTRACT

A computer implemented method is disclosed for facilitating execution of a Machine Learning (ML) model by a system of resource nodes, the ML model comprising a plurality of functional model parts. The method, performed by a resource node of the system, comprises generating a placement map for the ML model, wherein the placement map specifies, for each of the functional model parts, a mapping between the functional model part and at least one resource node of the system that is to execute the functional model part. The method further comprises identifying, from the placement map, a functional model part that is to be executed by the resource node, and executing the identified functional model part.

### TECHNICAL FIELD

The present disclosure relates to methods for facilitating execution of a Machine Learning (ML) model by a system of resource nodes. The present disclosure also relates to resource nodes of a system, and to a computer program and a computer program product configured, when run on a computer to carry out methods for facilitating execution of a Machine Learning (ML) model by a system of resource nodes.

### BACKGROUND

Machine Learning (ML) models may be used by devices, systems, networks etc. to enable new or enhanced functionality, for example through prediction, inference of information and/or decision making. Machine Learning generally refers to the use of algorithms and statistical models to perform a task, and usually involves a training phase, in which algorithms build a computational operation based on some sample input data, and an inference phase, in which the computational operation is used to make predictions or decisions without being explicitly programmed to perform the task. ML models are trained with data that consists of past experiences, or is constructed from a set of examples. Decision making models may implement logic that selects an action upon the basis of predictions provided by an ML model.

Factors including data privacy concerns, latency, and resource availability have given rise to an increase in distributed ML solutions, many of which are based on ensemble learning. Ensemble learning builds a set of classifiers with the aim of improving the accuracy of a single classifier. The most common method for ensemble learning builds the set of classifiers by training each individual classifier on different subsets of data. The trained individual classifiers are then combined in a specific manner that is defined by the ensemble algorithm. The ensemble approach is consequently highly applicable to a distributed environment, as individual classifiers can be trained at different distributed sites, each classifier being trained with data stored at that particular site.

Distributed and ensemble solutions can also be applied to decision making problems, as illustrated in FIG. 1. The upper part of FIG. 1 illustrates a classic Reinforcement Learning (RL) scenario, in which an agent 102 receives information about the state of an environment 104, on the basis of which it selects an action for execution in the environment 104. The action transitions the environment 104 into a new state, and generates Reward according to a reward function which has been designed to favour progression of the environment towards a desirable state. Information about the new state and generated Reward are received by the agent 102, which selects a new action for execution in the environment.

The lower part of FIG. 1 illustrates a multi-agent RL scenario, in which a plurality of agents each interact with the same environment. Each agent may receive differing state and reward information from the environment, according to the particular focus of the agent, and each agent selects an agent specific action. Actions from each agent may be combined for execution within the environment. In this manner, different aspects of environment management may be handled by different agents, each basing action selections on their own specific subset of state information and their own reward function.

Federated learning is another example of a distributed learning solution, in which local ML models are trained at distributed sites using local data sets available at those sites. The parameters of the locally trained models are then forwarded to a centralised location, at which a central, shared version of the model is generated from the received parameters. The central model is then distributed to the local sites, and may be further updated using the local data sets.

The above discussed distributed learning solutions seek to exploit the advantages of distributed and cloud based computing, and address many of the issues regarding data privacy, resource availability, etc. that may be experienced by centralised ML solutions. However, distributed solutions may also suffer from disadvantages, one of which is the inability to react rapidly to changing requirements or priorities for ML functionality within a system, network, deployment, etc. Cloud computing offers considerable flexibility in the allocation of cloud resources to a particular task at any given time, and instances of particular virtualised functions can be created and abandoned according to overall system requirements. However, in general, once an ML model has been trained, the model parameters and structure cannot be changed without requiring complete retraining of the model. This is a time consuming process, as previous learning cannot be transferred to the new structure, and so the parameters of the new model structure must be re-initialised. Model training is relatively resource intensive, and the model is unavailable for performing its task while retraining is carried out. For example, if a Neural Network (NN) is trained for a task, and the importance of that task increases, justifying the dedication of additional computing resources to that task, additional hidden layers cannot be added to the NN without completely retraining the NN from scratch.

Security is another ongoing concern which is not completely addressed by distributed solutions. For example in federated learning, while extensive transfer of potentially sensitive training data is avoided, the shared version of the model is distributed to all local nodes, and consequently a third party need only compromise one such local node to obtain the model structure.

### SUMMARY

It is an aim of the present disclosure to provide methods, nodes and a computer readable medium which at least partially address one or more of the challenges discussed above. It is a further aim of the present disclosure to provide methods, nodes and a computer readable medium which cooperate to facilitate execution of an ML model by a system of resource nodes in a flexible manner.

According to a first aspect of the present disclosure, there is provided a computer implemented method for facilitating execution of a Machine Learning (ML) model by a system of resource nodes, wherein the ML model comprises a plurality of functional model parts. The method, performed by a resource node of the system, comprises generating a placement map for the ML model, wherein the placement map specifies, for each of the functional model parts, a mapping between the functional model part and at least one resource node of the system that is to execute the functional model part. The method further comprises identifying, from the placement map, a functional model part that is to be executed by the resource node performing the method, and executing the identified functional model part.

According to another aspect of the present disclosure, there is provided a computer program product comprising a computer readable medium, the computer readable medium having computer readable code embodied therein, the computer readable code being configured such that, on execution by a suitable computer or processor, the computer or processor is caused to perform a method according to any one or more of aspects or examples of the present disclosure.

According to another example of the present disclosure, there is provided a resource node of a system of resource nodes, the resource node for facilitating execution of a Machine Learning (ML) model by the system, wherein the ML model comprises a plurality of functional model parts. The resource node comprises processing circuitry configured to cause the resource node to generate a placement map for the ML model, wherein the placement map specifies, for each of the functional model parts, a mapping between the functional model part and at least one resource node of the system that is to execute the functional model part. The processing circuitry is further configured to cause the resource node to identify, from the placement map, a functional model part that is to be executed by the resource node, and execute the identified functional model part.

Aspects of the present disclosure thus provide methods according to which an ML model may be executed by a system of resource nodes, each resource node executing a functional part of the model. In this manner, if any one resource node is compromised, only one part of the model structure is disclosed, significantly improving model security. In addition, model sharing and real-time restructuring of a deployed ML model can be supported through the use and reassignment of resource nodes.

### BRIEF DESCRIPTION OF THE DRAWINGS

For a better understanding of the present disclosure, and to show more clearly how it may be carried into effect, reference will now be made, by way of example, to the following drawings in which:

FIG. 1 illustrates application of a distributed solution to a Reinforcement Learning problem;

FIG. 2 illustrates functional building blocks combining to execute an ML model;

FIG. 3 is a flow chart illustrating process steps in a method for facilitating execution of an ML model by a system of resource nodes;

FIGS. 4a to 4g show flow charts illustrating process steps in another example of computer implemented method for facilitating execution of an ML model by a system of resource nodes;

FIG. 5 is a block diagram illustrating functional modules in an example resource node;

FIG. 6 is a block diagram illustrating functional modules in another example resource node;

FIGS. 7a to 7c illustrate Loss-epoch curves for a training of a Neural Network;

FIGS. 8a to 8c illustrate example processes for the generation of a placement map;

FIGS. 9a to 9d illustrate an example of how a NN may be executed using a system of resource nodes; and

FIGS. 10a to 10d illustrate mutation of a Neural Network to add a new layer.

### DETAILED DESCRIPTION

As noted above, it would be desirable to be able to add or remove parts of an ML model on-the-fly without needing to retrain the model from scratch. For example, if two trained NN models are each performing an independent task, the ability to remove some hidden layers from one model and attach the layers to the other model, without having to retrain both models from scratch, would open a range of possibilities for resource sharing, model sharing, adaptive and reactive network management etc., which offer considerable technical and commercial advantages. This ability to change model structure would be particularly useful for deployment scenarios in which the memory and processing power is limited, and it is consequently desirable to use these resources in a manner that is optimised with respect to overall system requirements, and which can be adapted in an on-demand fashion as system requirements evolve.

Aspects of the present disclosure propose to provide the above discussed functionality through the introduction of functional building blocks that can combine to execute an ML model. These building blocks may be considered as Artificial Intelligence (AI) stem cells, in that they may be configured to perform a range of different functions according to the needs of the system. The functional building blocks proposed herein differ from the entities proposed in distributed, federated and other ensemble learning techniques in that no one building block can be considered as a complete ML or AI entity, capable of performing a task, however simple. Ensemble techniques generally involve a group, which may be referred to as a swarm, of AI or ML entities, which work together to perform a complex task. The entities may each perform individual tasks, contributing to the execution of the complex task by the group, or each entity may perform the same task, for example in a slightly different manner or using different parameters, as discussed above. In contrast, each functional building block of the present disclosure is merely capable of performing a function, such as writing values to memory, performing a computation, executing an activation function etc. Each function performed by a functional building block contributes to the execution of an ML model but is incomplete on its own. The building blocks must be combined in order to form a complete ML model that receives a model input, processes the input according to the model parameters, and produces a model output.

The functional building blocks of the present disclosure allow for a process that may be envisaged as ML model mutation, in which changes are made to the structure of an ML model in real time without the need for retraining the entire model. Examples of the present disclosure propose a process for such mutation, in which a building block which is part of a first model may leave the first model and join a second model, without requiring complete retraining of either model.

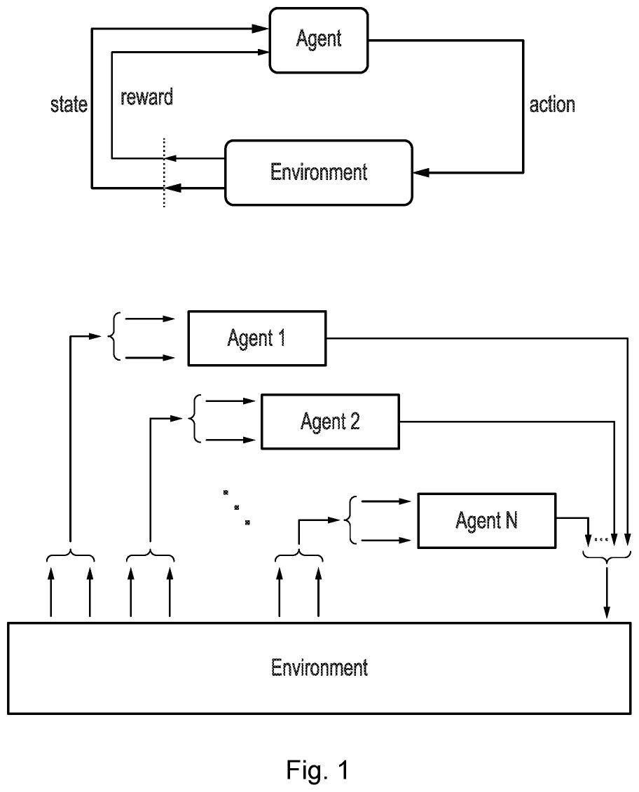

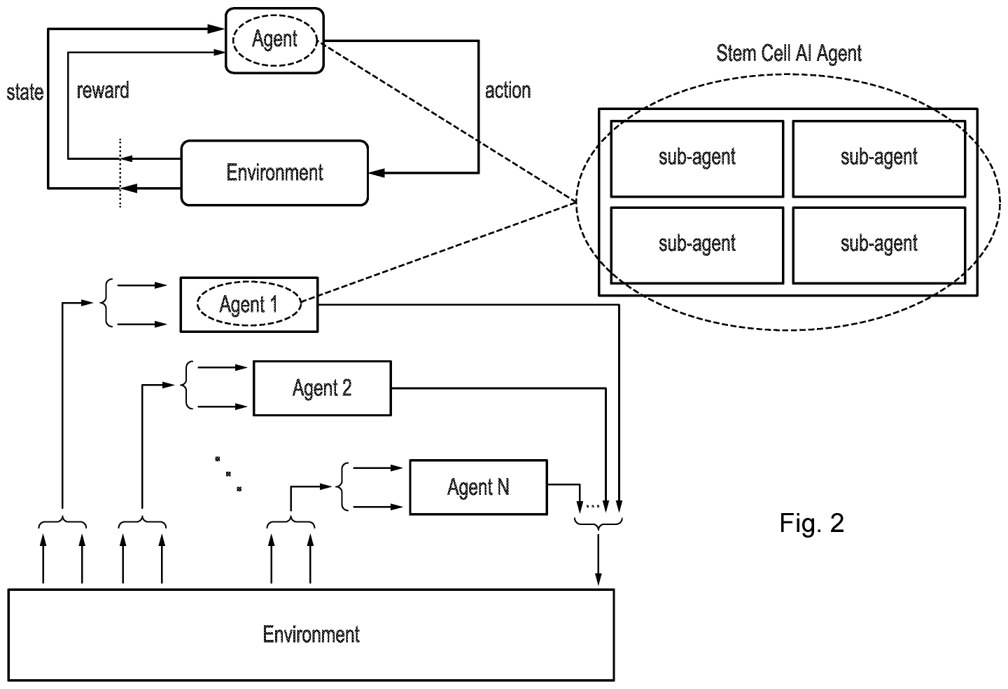

The concept of functional building blocks, and its differentiation from multi-agent or multi-model solutions, is illustrated in FIG. 2. FIG. 2 shows the classic RL scenario of FIG. 1, as well as the multi-agent scenario, in which multiple ML agents each manage an aspect of the environment 204. The functional building blocks of the present disclosure may be used to execute any of the agents illustrated in FIG. 2, including the single agent of the classic scenario, or any of the agents of the multi-agent scenario. These functional building blocks are illustrated as sub agents, or stem cell AI agents, in FIG. 2. Any one sub-agent is incapable of executing an entire ML model, and it is only in cooperation with other sub-agents that a complete ML model can be executed.

According to examples of the present disclosure, the functional building blocks discussed above are implemented by resource nodes, which may be physical or virtual nodes. Resource nodes may comprise a managing agent and at least one unit of storage resource, computational resource and/or networking resource. The resources available to a resource node may be dynamic, and resource nodes may consequently obtain or release resource according to the particular function that they are to execute.

Aspects of the present disclosure also introduce a continuous training methodology that is implemented via the functional building blocks discussed above, and allows for an ML model to be trained while in deployment. This continuous training methodology supports the gradual mutation of ML models via the removal and addition of functional blocks, and is different from “Incremental learning” in which an ML model is continuously enriched by new data set records. Model mutation and continuous training are discussed in greater detail below.

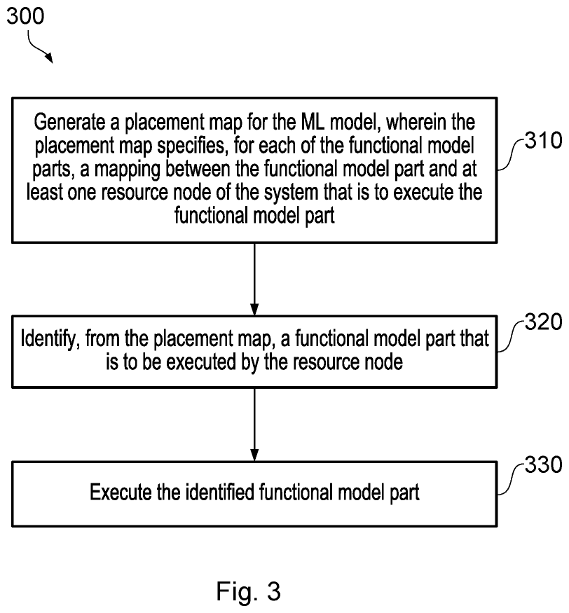

FIG. 3 is a flow chart illustrating process steps in a computer implemented method 300 for facilitating execution of a Machine Learning (ML) model by a system of resource nodes, wherein the ML model comprises a plurality of functional model parts. The method is performed by a resource node of the system. The resource node may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. A resource node may be implemented in any part of a network or system in which an ML model is to be executed to perform a task. In the context of communication networks, a resource node may for example be implemented in a core network, and may be implemented in an Operation Support System (OSS), Orchestration And Management (OAM) system or in a Service Management and Orchestration (SMO) system. In other examples, a resource node may be implemented in a Radio Access node, which itself may comprise a physical node and/or a virtualized network function that is operable to exchange wireless signals. In some examples, a Radio Access node may comprise a base station node such as a NodeB, eNodeB, gNodeB, or any future implementation of this functionality. A resource node may be implemented as a function in an Open Radio Access Network (ORAN) or Virtualised Radio Access Network (vRAN). A resource node may encompass multiple logical entities, as discussed in greater detail below, and may for example comprise a Virtualised Network Function (VNF).

Referring to FIG. 3, the method 300 comprises generating a placement map for the ML model in step 310, wherein the placement map specifies, for each of the functional model parts, a mapping between the functional model part and at least one resource node of the system that is to execute the functional model part. The method further comprises, in step 320, identifying, from the placement map, a functional model part that is to be executed by the resource node, and, in step 330, executing the identified functional model part.

The method 300 may be performed by any resource node, regardless of the role it assumes in any given ML model through execution of the functional model part to which it is mapped. The method 300 exploits the concept of dividing an ML model into functional parts, with each part executed by a resource node in the system, and with correspondence between model parts and resource nodes determined by a placement map. The placement map is generated by the individual resource nodes, meaning each node has full visibility of what parts of the model are to be executed by other resource nodes.

For the purposes of the present disclosure, it will be appreciated that an ML model is considered to comprise the output of a Machine Learning algorithm or process, wherein an ML process comprises instructions through which data may be used in a training procedure to generate a model artefact for performing a given task, or for representing a real world process or system. An ML model is the model artefact that is created by such a training procedure, and which comprises the computational architecture that performs the task. A functional part of an ML model comprises a part of the computational architecture of the model. A functional part of an ML model may for example comprise a specific memory structure and one or more computational operations to be executed on values written into the memory structure, and the result of which may be written to other parts of the memory structure. For example, in the case of a Neural Network, a functional model part may comprise a layer of the NN, a part of a NN layer, a plurality of NN layers etc. The layer or layers may comprise an input layer, output layer, hidden layer, orchestration layer etc. In the case of a kNN (k-nearest neighbours algorithm) classifier, a functional model part may comprise a unique portion of training data set. In the case of a random forest, a functional model part may comprise a unique set of decision trees.

The method 300 offers considerable advantages in terms of security and resource conservation over conventional deployment options for ML models. For example, if one resource node is compromised by a malicious third party, then only that part of the model is comprised, and the third party would have to compromise all resource nodes executing the model in order to obtain the full model. In addition, by executing an ML model via a plurality of resource nodes, each resource node executing a separate functional model part, the infrastructure is provided to support model mutation, according to which functional parts may be moved from one model to another reflecting evolving priorities for the tasks the models are performing. In this manner, computational, memory, networking and other resources may be distributed between tasks in a dynamic manner, reflecting current network priorities for the different tasks, and without wasting previous model training by requiring extensive retraining of individual models. A process for implementing this model mutation, executed via example enhancements and additions to the method 300, is discussed in detail below.

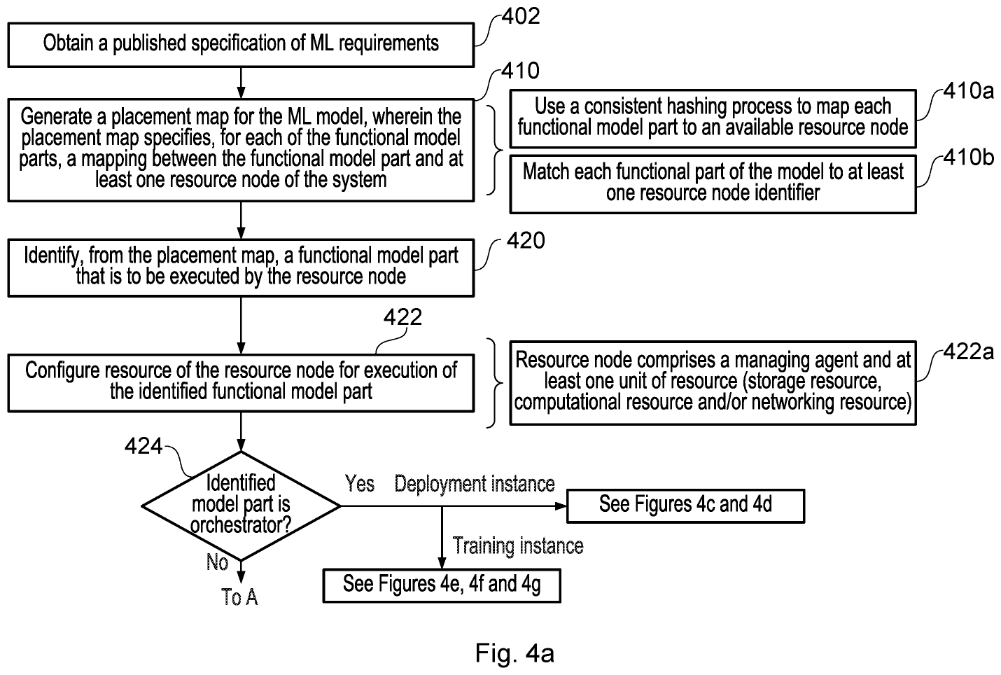

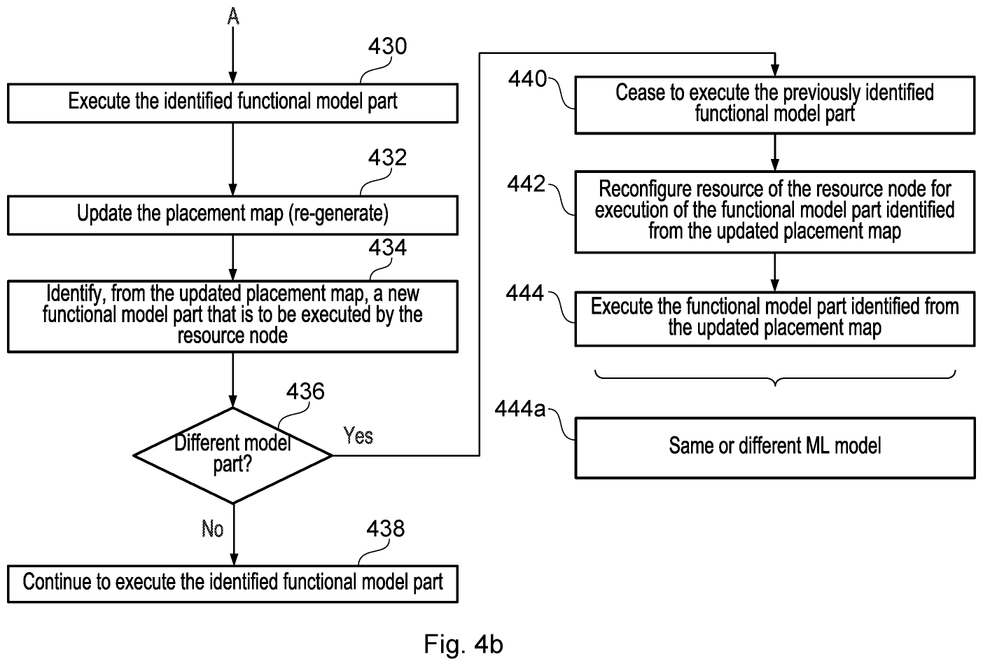

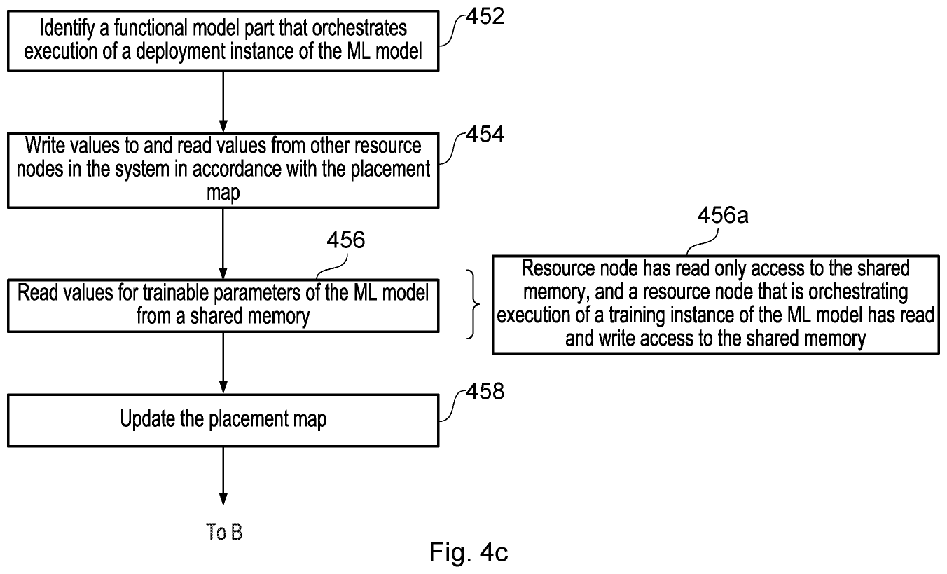

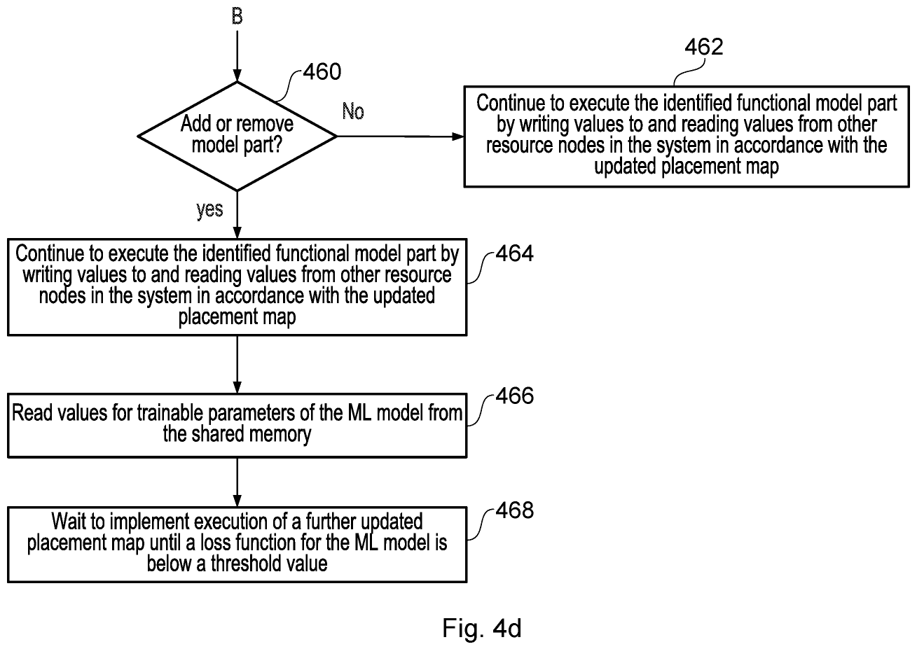

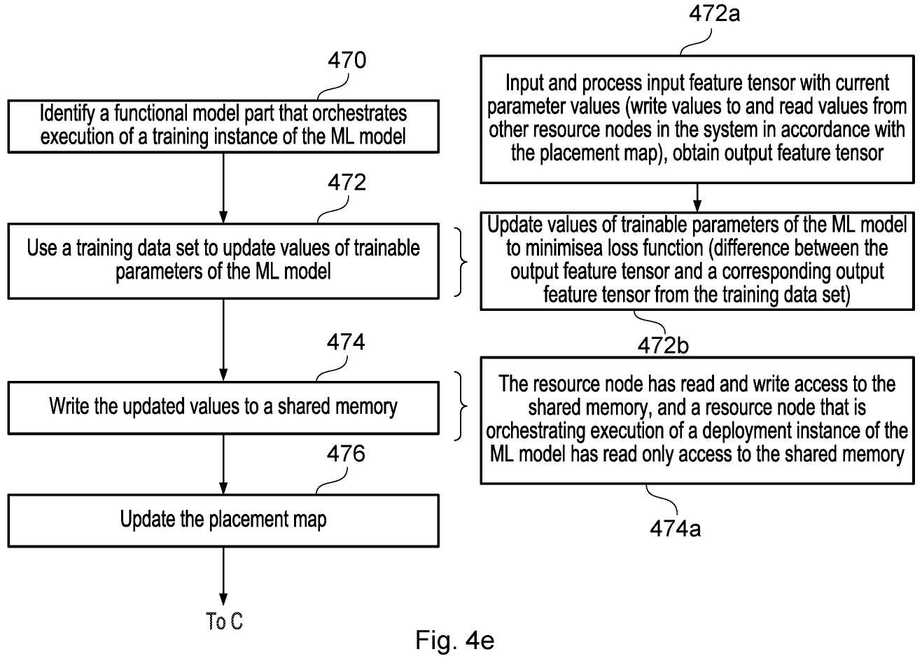

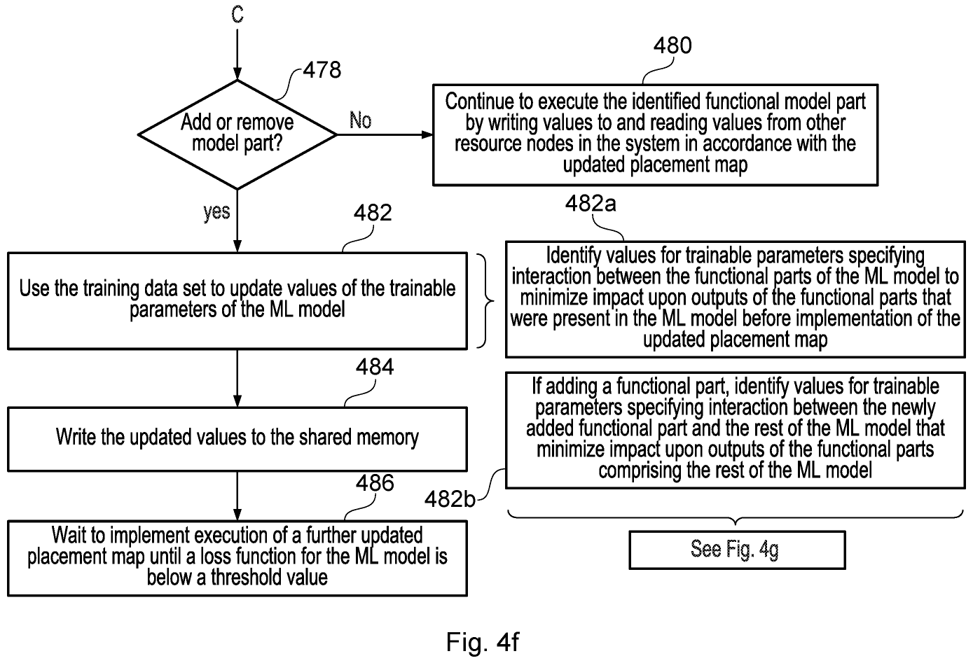

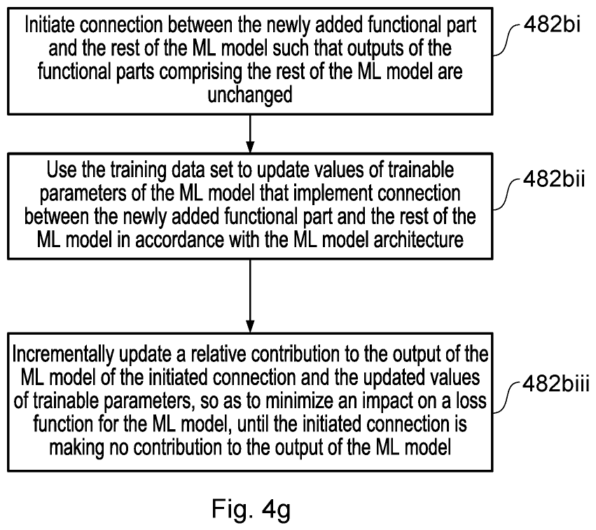

FIGS. 4a to 4g show flow charts illustrating process steps in another example of computer implemented method 400 for facilitating execution of an ML model by a system of resource nodes, wherein the ML model comprises a plurality of functional model parts. The method 400 provides various examples of how the steps of the method 300 may be implemented and supplemented to achieve the above discussed and additional functionality. As for the method 300, the method 400 is performed by a resource node that is a part of a system of resource nodes. As discussed above with reference to the method 300, the resource node performing the method 400 may comprise a physical or virtual node, and may be implemented in a computer system, computing device or server apparatus and/or in a virtualized environment, for example in a cloud, edge cloud or fog deployment. Examples and implementation options for the resource node are discussed above with reference to the method 300.

Referring initially to FIG. 4a, in a first step 402, the resource node obtains a published specification of requirements for one or more ML tasks to be performed by the ML model or models that the system of resource nodes will execute. This may for example comprise a published list of Artificial Intelligence (AI) tasks for execution by the system of resource nodes. The resource node performing the method 400 then generates a placement map for the ML model or models to be executed in step 410, wherein the placement map specifies, for each of the functional model parts, a mapping between the functional model part and at least one resource node of the system that is to execute the functional model part. As illustrated at 410a, generating a placement map may comprise using a consistent hashing process to divide the ML model into its functional model parts and to map each of the functional model parts to an available resource node in the system. In further examples of the method 400, other processes or algorithms that can accomplish the same results as consistent hashing may be used to generate the placement map.

A range of consistent hashing algorithms exists, and in one example of the present disclosure, the consistent hashing algorithm may comprise the DataFall algorithm disclosed by Fereydoun Farrahi Moghaddam, Wubin Li, and Abdelouahed Gherbi in “DataFall: A policy driven algorithm for decentralized placement and reorganization of replicated data”, 2018 IEEE Intl Conference on Parallel & Distributed Processing with Applications, Ubiquitous Computing & Communications, Big Data & Cloud Computing, Social Computing & Networking, Sustainable Computing & Communications.

As illustrated at 410b, each resource node in the system may have a unique identifier, and using a consistent hashing process to divide the ML model into its functional model parts and to map each of the functional model parts to an available resource node in the system may comprise matching each functional part of the model to at least one resource node identifier. The number of functional parts into which the model is divided may be dictated by the number of resource nodes in the system, the resources available etc.

In step 420, the resource node identifies, from the placement map, a functional model part that is to be executed by the resource node, that is the functional model part to which the resource node is mapped in the placement map. The resource node then, in step 422, configures resource of the resource node for execution of the identified functional model part. This configuring step may comprise requesting additional resource, releasing unnecessary resource that is currently under control of the resource node, and/or structuring resource appropriately for execution for the functional model part. The configuring step may further comprise determining, based on the identified functional model part, what resource is required by the resource node in order to execute the functional model part. This may comprise using an appropriate ML framework or library for the ML model.

As illustrated at 422a, the resource node may comprise a managing agent and at least one unit of resource, the resource comprising at least one of storage resource, computational resource, and/or networking resource. The managing agent may comprise a physical or virtual entity that is operable to manage resource. Examples of a physical entity may include a computer system, computing device, server etc. Examples of a virtual entity may include piece of software or computer program, a code fragment operable to implement a computer program, a virtualized function or any other logical entity. A virtual entity may for example be instantiated in a cloud, edge cloud or fog deployment. Resource of any given resource node may be dynamic, and the resource managed by the managing agent may be a physical or virtual resource, and may for example be a cloud resource.

In step 424, the resource node may determine whether or not the identified functional model part to be executed by the resource node comprises a functional model part that orchestrates execution of the ML model. Execution of the functional model part may comprise different sub steps according to whether or not the functional model part performs an orchestration role. If the identified functional model part orchestrates execution of an instance of the ML model, then the resource node carries out steps illustrated in FIGS. 4c and 4d (for orchestration of a deployment instance of the ML model), or carries out the steps illustrated in FIGS. 4e, 4f and 4g (for orchestration of a training instance of the ML model). FIGS. 4c to 4g are discussed in detail below.

If the identified functional model part does not orchestrate execution of either a training or a deployment instance of the ML model, the resource node carries out the steps illustrated in FIG. 4b. Referring now to FIG. 4b, the resource node executes the identified functional model part in step 430. This may comprise performing one or more computational operations, for example comprising activation functions for particular neurons in a layer of a neural network that the resource node is executing. The resource node may for example perform the one or more computational operations on values written to a memory of the resource node by another resource node that is executing orchestration of the ML model. The resource node may then write a result of the one or more computations to an area of memory where it can be read by the resource node that is executing orchestration of the ML model.

In step 432, the resource node updates the placement map. This may comprise for example regenerating the placement map from scratch, or regenerating a part of the placement map, for example to take account of changes in the functional model parts to be executed and/or in the resources available for execution of functional model parts. The placement map may be updated in a scheduled manner, periodically, or on occurrence of a trigger. The trigger may for example comprise a change in a published specification of requirements for one or more ML tasks executed by the ML model or models (for example a change in a published list of AI tasks for execution by the system of resource nodes). Alternatively the trigger may comprise a change in the availability of resource nodes in the system for execution of the one or more ML models. For example if a resource node or its resources become unavailable, or if additional resources and/or resource nodes become available, then this may trigger updating of the placement map. Updating the placement map may comprise using the same process as was used at step 410 to generate the placement map. As discussed above, this may comprise a consistent hashing algorithm, such as the DataFall algorithm introduced above. Updating the placement map allows new ML model requirements to be resourced, and the use of consistent hashing to match functional model parts to resource nodes minimizes the reorganization and reallocation of existing functional model parts. The following example illustrates how the DataFall consistent hashing process can be used to update a placement map.

In an illustrative example, two ML tasks, MLT1 and MLT2, are to be carried out by a system of 6 resource nodes: RN1 to RN6. Each resource node uses the DataFall process to generate the same placement map, resulting in an initial distribution of ML model tasks to resource nodes as follows:

MLT1={SA2,SA3,SA6}

MLT2={SA1,SA4,SA5}.

A change is then introduced in the form of an additional ML task, MLT3, to be performed by the system, meaning the 6 resource nodes now need to be distributed between MLT1, MLT2 and MLT3. If standard hashing were used to update the placement map, then the distribution of resource nodes to ML model tasks would be random, and the previous distribution of ML model tasks to resource nodes would be completely discarded, meaning the new distribution could be for example:

MLT1={SA1,SA4},

MLT2={SA2,SA6},

MLT3={SA3,SA5}.

It can be seen that all the resource nodes are now matched with a new model task, meaning that all of the resource nodes need to be reconfigured for their new tasks, and nothing from the original models can be retained as a basis upon which to build. In contrast, a consistent hashing process such as DataFall seeks to minimize the disruption to the initial distribution of tasks to resource nodes. DataFall may therefore update the placement map as follows:

MLT1={SA2,SA6},

MLT2={SA4,SA5},

MLT3={SA1,SA3}.

In the above rearrangement, changes to the initial distribution of ML model tasks to resource nodes are minimized. Two of the original resource nodes that executed task MLT1 are still executing task MLT1, and two of the original resource nodes that executed task MLT2 are still executing task MLT2. These resource nodes do not therefore require complete reconfiguration.

In another illustrative example, the change introduced may be a change in the relative priorities of tasks MLT1 and MLT2. For example, network circumstances may mean that task MLT2 becomes more important, and there is a need to allocate four resource nodes to task MLT2 and only two resource nodes to task MLT1. As discussed above, if standard hashing were used then the resource nodes would be completely redistributed randomly between the two tasks. With consistent hashing, a majority of the original distribution will be maintained, with only one resource node being reassigned from MLT1 to MLT2, thus causing a minimum of disturbance to the existing operation of the models.

Referring still to FIG. 4b, after updating the placement map, the resource node identifies, from the updated placement map, a new functional model part that is to be executed by the resource node. If the identified functional model part is the same as the part that the resource node was executing before the update of the placement map (No at step 436), then the reassure node continues to execute the identified functional model part at step 438, until either a new update of the placement map is triggered or scheduled, or some other event occurs resulting in a suspension or ending of the process.

If at step 436 the resource node determines that the identified functional model part from the updated placement map is different to the model part that the resource node was previously executing, then the resource node initially ceases to execute the previously identified functional model part at step 440, and then, at step 442, reconfigures resource of the resource node for execution of the functional model part identified from the updated placement map. In step 444, the resource node executes the functional model part identified from the updated placement map.

As mentioned above, the method 400 may be for facilitating execution of a plurality of ML models, and it is possible that the functional model part identified from the updated placement map and the previously identified functional model part may be functional parts of different ML models, or of the same ML model, as illustrated at 444a. In the case of different models, the models may also be of different types, for example the resource node may initially execute a layer of a neural network model, and, following placement map update, may then execute a part of a k Nearest neighbors model. The resource node may initially reconfigure its managed resources in accordance with the new functional model part. The resource node will continue executing the newly identified functional model part at step 444, until either a new update of the placement map is triggered or scheduled, or some other event occurs resulting in a suspension or ending of the process.

As discussed above, FIGS. 4c and 4d illustrate steps carried out by the resource node if, at step 424, the resource node determines that the functional ML model part that it has identified from the placement map as being for execution by the resource node is a functional model part that orchestrates execution of a deployment instance of the ML model.

Deployment and training instances of an ML model are discussed in greater detail below, with respect to example implementations of the methods discussed herein. However, in brief, deployment and training instances of an ML model are separate instances of the same model. The deployment and training instances thus have the same model structure, and have separate and independent computational and memory resources for execution of each instance. Deployment and training instances of the same ML model only have one shared memory, and that is a memory in which the values of trainable parameters of the model are stored. As discussed in further detail below, the deployment instance of the model has read only access to the shared memory, while the training instance has read and write access, meaning the training instance can update values of the trainable parameters, and the deployment instance or instances may read these updated values each time the deployment instances execute the model. It will be appreciated that only the memory in which the values for trainable model parameters are stored is shared between the training and deployment instances of the model, and that otherwise the two instances execute the same model but entirely independently, using different resource nodes for model execution. In this manner, continuous training of the model may take place, even while the model is simultaneously being used in a live deployment.

Referring now to FIG. 4c, in step 452, the resource node identifies, from the placement map, a functional model part that is to be executed by the resource node that orchestrates execution of a deployment instance of the ML model. In the case of a neural network model, this may comprise a “Layer 1” neural network layer, which executes the model by reading and writing values from/to the different resource nodes that are executing the model. The resource node then executes the identified functional model part by writing values to and reading values from other resource nodes in the system in accordance with the placement map. As illustrated at step 456, executing the identified functional model part may further comprise reading values for trainable parameters of the ML model from a shared memory. The resource node may have read only access to the shared memory as discussed above, and a resource node of the system that is orchestrating execution of a training instance of the ML model may have read and write access to the shared memory.

In step 456, the resource node updates the placement map, which may be achieved in the same manner as described above with respect to step 432. As for the initial generation of the placement map, all resource nodes in the system that are executing the method 400 update the placement map using the same process (consistent hashing for example), when scheduled or on occurrence of a trigger. The updating process described above for a resource node that is executing a functional model part other than orchestration is consequently the same update process as is performed by a resource node that is executing an orchestration functional model part in accordance with the steps of FIGS. 4c and 4d.

Following updating of the placement map, the resource node may identify a new functional model part from the updated placement map, which is to be executed by the resource node, substantially as discussed above with reference to FIG. 4b. If the identified functional model part is the same as the part that the resource node was executing before the update of the placement map, then the reassure node continues to orchestrate execution of the ML model, as discussed further below. If the resource node determines that the identified functional model part from the updated placement map is different to the model part that the resource node was previously executing, then the resource node reconfigures its resources for execution of the new functional model part. As discussed above, the nature of the consistent hashing process used in generating and updating the placement map is to minimize changes to an existing distribution of ML functional model parts to resource nodes, and so for the purposes of FIGS. 4c and 4d, it is assumed that the resource node is to continue executing the functional model part that orchestrates execution of a deployment instance of the ML model.

Referring now to FIG. 4d, at step 460, the resource node determines whether the updated placement map has added or removed a functional model part and/or resource node to/from the ML model instance that it is orchestrating execution of. If the updated placement map does not specify addition or removal of a functional part of the model and/or resource node, then the resource node continues to execute the identified functional model part at step 462 by writing values to and reading values from other resource nodes in the system in accordance with the substantially unchanged updated placement map.

If the updated placement map specifies addition or removal of a functional part of the model and/or resource node, then the resource node continues to execute the identified functional model part by writing values to and reading values from other resource nodes in the system in accordance with the updated placement map in step 464. The resource node also continues to read values for trainable parameters of the ML model from the shared memory at step 466.

It will be appreciated that even following addition or removal of a functional model part, the resource node may continue orchestrating execution of the ML model without waiting for a pause to allow retraining. The values of the trainable parameters that are read from the shared memory may update as the training instance adapts to the model reconfiguration, but owing to the use of consistent hashing to minimize model disruption as discussed above, and the granular mutation of the model implemented by the training instance (see FIGS. 4e to 4g and discussion below), the impact of the model reconfiguration on the model loss function is minimized, ensuring the model remains usable even as it is reconfigured.

In step 468, the resource node waits to implement execution of a further updated placement map until a loss function for the ML model is below a threshold value. This threshold value may be managed by a resource node executing orchestration of a training instance of the ML model. In one example, the resource node executing orchestration of a training instance of the ML model may set a flag on the shared memory to be true when the values of the trainable parameters in the shared memory are available for use by the deployment instance. If the flag is false then the deployment instance may use a locally stored copy of the previous version of the trainable parameter values. In this manner, the resource node executing orchestration of a training instance of the ML model may ensure that the deployment instance only uses values of the trainable parameters that are consistent with a loss function value that is below a threshold value. A flag may similarly be used to manage staged implementation of addition or removal of multiple functional model parts. For example, if an updated placement map specifies addition of a plurality of functional model parts, then these model parts may be added one by one, with the training instance of the model using a flag to indicate when the loss function has stabilized and the next functional model part may be added. It will be appreciated that addition of a functional model part is implemented by the resource node executing orchestration of the model instance writing values to and reading values from memory controlled by the resource node executing the new model part.

As discussed above, FIGS. 4e, 4f and 4g illustrate steps carried out by the resource node if, at step 424, the resource node determines that the functional ML model part that it has identified from the placement map as being for execution by the resource node is a functional model part that orchestrates execution of a training instance of the ML model.

Referring now to FIG. 4e, in step 470, the resource node identifies, from the placement map, a functional model part that is to be executed by the resource node that orchestrates execution of a training instance of the ML model. In the case of a neural network model, this may comprise a “Layer 1” neural network layer, which executes the model by reading and writing values from/to the different resource nodes that are executing the model. The resource node then executes the identified functional model part in step 472 by using a training data set to update values of trainable parameters of the ML model. As illustrated in FIG. 4e, this may comprise, in step 472a inputting an input feature tensor from the training data set to the training instance of the ML model, causing the training instance of the ML model to process the input feature tensor in accordance with current values of trainable parameters of the ML model, and obtaining an output feature tensor from the training instance of the ML model. As illustrated at step 472a, the resource node writes values to and reads values from other resource nodes in the system in accordance with the placement map. Using the training data set to update values of the trainable parameters of the ML model further comprises, in step 472b, updating the values of the trainable parameters of the ML model so as to minimise a loss function based on a difference between the output feature tensor from the training instance of the ML model and an output feature tensor from the training data set that corresponds to the input feature tensor.

In step 474, the resource node writes the updated values to a shared memory. As illustrated at 474a and as discussed above, the resource node has read and write access to the shared memory, and a resource node that is orchestrating execution of a deployment instance of the ML model has read only access to the shared memory.

In step 476, the resource node updates the placement map, which may be achieved in the same manner as described above with respect to step 432. As for the initial generation of the placement map, all resource nodes in the system that are executing the method 400 update the placement map using the same process (consistent hashing for example), when scheduled or on occurrence of a trigger. The updating process described above for a resource node that is executing a functional model part other than orchestration is consequently the same update process as is performed by a resource node that is executing an orchestration functional model part in accordance with the steps of FIGS. 4e to 4g.

Following updating of the placement map, the resource node may identify a new functional model part from the updated placement map, which is to be executed by the resource node, substantially as discussed above with reference to FIG. 4b. If the identified functional model part is the same as the part that the resource node was executing before the update of the placement map, then the reassure node continues to orchestrate execution of the ML model, as discussed below. If the resource node determines that the identified functional model part from the updated placement map is different to the model part that the resource node was previously executing, then the resource node reconfigures its resources for execution of the new functional model part. As discussed above, the nature of the consistent hashing process used in generating an updated placement map is to minimize changes to an existing distribution of ML functional model parts to resource node, and so for the purposes of FIGS. 4e to 4g, it is assumed that the resource node is to continue executing the functional model part that orchestrates execution of a training instance of the ML model. Referring now to FIG. 4f, the resource node determines at step 478 whether the updated placement map has added or removed a functional model part and/or resource node to/from the ML model instance that it is orchestrating execution of. If the updated placement map does not specify addition or removal of a functional part of the model and/or resource node, then the resource node continues to execute the identified functional model part at step 480 by writing values to and reading values from other resource nodes in the system in accordance with the updated placement map.

If the updated placement map specifies addition or removal of a functional part of the model and/or a resource node, then the resource node continues to execute the identified functional model part by using the training data set to update values of the trainable parameters of the ML model; writing values to and reading values from other resource nodes in the system in accordance with the updated placement map. Steps that may be performed in order to achieve the training process of step 482, following addition or removal of a functional model part, are illustrated in FIG. 4f and discussed below.

As illustrated at 482a, using the training data set to update values of the trainable parameters of the ML model may comprise identifying values for trainable parameters of the ML model that specify interaction between the functional parts of the ML model, which values minimize impact upon outputs of the functional parts that were present in the ML model before implementation of the updated placement map. In this manner, the method 400 seeks to preserve as much learning as possible from before the change to the model structure, minimizing impact on model output so the deployment instance of the ML model is still usable, even as the training of the reconfigured model continues.

As illustrated at 482b, if the updated placement map specifies addition of a functional part of the model, then using the training data set to update values of the trainable parameters of the ML model may comprise identifying values for trainable parameters of the ML model that specify interaction between the newly added functional part and the rest of the ML model that minimize impact upon outputs of the functional parts comprising the rest of the ML model. A process by which this may be achieved is illustrated in FIG. 4g.

Referring now to FIG. 4g, the resource node may first initiate connection between the newly added functional part and the rest of the ML model in step 482bi, such that outputs of the functional parts comprising the rest of the ML model are unchanged. The resource node may then use the training data set to update values of trainable parameters of the ML model that implement connection between the newly added functional part and the rest of the ML model in accordance with the ML model architecture at step 482bii. The trainable parameters may be weights, and may include an activation function. Finally, the resource node may incrementally update a relative contribution to the output of the ML model of the initiated connection and the updated values of trainable parameters, so as to minimize an impact on a loss function for the ML model, until the initiated connection is making no contribution to the output of the ML model. The process illustrated in FIG. 4g thus implements an incremental or granular mutation of the model to accommodate a newly added model part while minimizing impact on a loss function for the model, thus ensuring that a deployment instance of the model remains useable throughout the mutation to a new model structure. It will be appreciated that a similar granular mutation procedure to that illustrated in the steps of FIG. 4g may be carried out in reverse for the removal of a functional part of an ML model. For example, a connection may first be initiated between the functional part for removal and the rest of the ML model such that the functional part for removal has no impact upon the output of the rest of the ML model. The resource node may then use the training data set to update values of trainable parameters of the ML model that implement connections between the rest of the ML model without the functional part to be removed in accordance with the ML model architecture. Finally, the resource node may incrementally update a relative contribution to the output of the ML model of the original connections between the parts of the ML model and the combination of initiated and updated connections, so as to minimize an impact on a loss function for the ML model, until the original connections are making no contribution to the output of the ML model. At this point the functional model part may be removed from the model without impacting the loss function.

Referring again to FIG. 4f, and following use of the training data set to update values of the trainable parameters of the ML model at step 482, the resource node then writes the updated values to the shared memory. It will be appreciated that the training data set used to update trainable parameters following a change to the ML model structure need not be updated with new data, but is the same training data set as was used to train the model before the addition or removal of a part of the model

In step 486, the resource node waits to implement execution of a further updated placement map until a loss function for the ML model is below a threshold value. This threshold value may be managed by the resource node executing orchestration of the training instance of the ML model. In one example, the resource node may set a flag on the shared memory to be true when the values of the trainable parameters in the shared memory are available for use by the deployment instance. If the flag is false then the deployment instance may use a locally stored copy of the previous version of the trainable parameter values. In this manner, the resource node executing orchestration of the training instance of the ML model may ensure that the deployment instance only uses values of the trainable parameters that are consistent with a loss function value that is below a threshold value. A flag may similarly be used to manage staged implementation of addition or removal of multiple functional model parts. For example, if an updated placement map specifies addition of a plurality of functional model parts, then these model parts may be added one by one, with the resource node using a flag to indicate when the loss function has stabilized and the next functional model part may be added.

As discussed above, the methods 300 and 400 may be performed by a resource node, and the present disclosure provides a resource node that is adapted to perform any or all of the steps of the above discussed methods. The resource node may comprise a physical or virtual node, and may be implemented in a computer system, computing device or server apparatus and/or in a virtualized environment, for example in a cloud, edge cloud or fog deployment. Examples of a virtual node may include a piece of software or computer program, a code fragment operable to implement a computer program, a virtualised function, or any other logical entity. A resource node may be implemented in any part of a network or system in which an ML model is to be executed to perform a task. In the context of communication networks, a resource node may for example be implemented in a core network, and may be implemented in an Operation Support System (OSS), Orchestration And Management (OAM) system or in a Service Management and Orchestration (SMO) system. In other examples, a resource node may be implemented in a Radio Access node, which itself may comprise a physical node and/or a virtualized network function that is operable to exchange wireless signals. In some examples, a Radio Access node may comprise a base station node such as a NodeB, eNodeB, gNodeB, or any future implementation of this functionality. A resource node may be implemented as a function in an Open Radio Access Network (ORAN) or Virtualised Radio Access Network (vRAN). A resource node may encompass multiple logical entities, as discussed in greater detail below, and may for example comprise a Virtualised Network Function (VNF).

FIG. 5 is a block diagram illustrating an example resource node 300 which may implement the method 300 and/or 400, as illustrated in FIGS. 3 to 4g, according to examples of the present disclosure, for example on receipt of suitable instructions from a computer program 550. Referring to FIG. 5, the resource node 500 comprises a processor or processing circuitry 502, and may comprise a memory 504 and interfaces 506. The processing circuitry 502 is operable to perform some or all of the steps of the method 300 and/or 400 as discussed above with reference to FIGS. 3 to 4g. The memory 504 may contain instructions executable by the processing circuitry 502 such that the resource node 500 is operable to perform some or all of the steps of the method 300 and/or 400, as illustrated in FIGS. 3 to 4g. The instructions may also include instructions for executing one or more telecommunications and/or data communications protocols. The instructions may be stored in the form of the computer program 550. In some examples, the processor or processing circuitry 502 may include one or more microprocessors or microcontrollers, as well as other digital hardware, which may include digital signal processors (DSPs), special-purpose digital logic, etc. The processor or processing circuitry 502 may be implemented by any type of integrated circuit, such as an Application Specific Integrated Circuit (ASIC), Field Programmable Gate Array (FPGA) etc. The memory 504 may include one or several types of memory suitable for the processor, such as read-only memory (ROM), random-access memory, cache memory, flash memory devices, optical storage devices, solid state disk, hard disk drive etc.

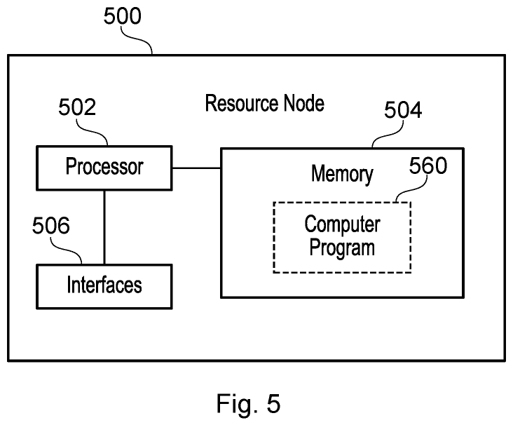

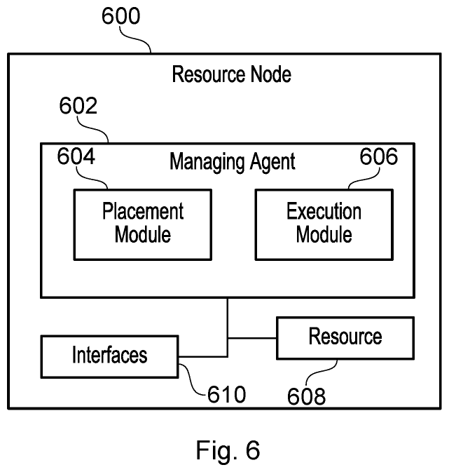

FIG. 6 illustrates functional units in another example of resource node 600 which may execute examples of the methods 300 and/or 400 of the present disclosure, for example according to computer readable instructions received from a computer program. It will be understood that the units illustrated in FIG. 6 are functional units, and may be realized in any appropriate combination of hardware and/or software. The units may comprise one or more processors and may be integrated to any degree.

Referring to FIG. 6, the resource node 600 is a part of a system of resource nodes. The resource node 600 is for facilitating execution of an ML model by the system, wherein the ML model comprises a plurality of functional model parts. The resource node 600 comprises a managing agent 602, and resource 608. The managing agent 602 comprises a placement module 604 for generating a placement map for the ML model, wherein the placement map specifies, for each of the functional model parts, a mapping between the functional model part and at least one resource node of the system that is to execute the functional model part. The placement module 604 is also for identifying, from the placement map, a functional model part that is to be executed by the resource node. The managing agent 602 also comprises an execution module 606 for executing the identified functional model part using the resource 608. The resource 608 may for example comprise memory resource, computing resource, networking resource, etc. The resource node 600 may further comprise interfaces 610 which may be operable to facilitate communication with other resource nodes in the system, and/or with other communication network nodes over suitable communication channels.

FIGS. 3 to 4g discussed above provide an overview of methods which may be performed according to different examples of the present disclosure. These methods may be performed by a resource node, as illustrated in FIGS. 5 and 6. There now follows a detailed discussion of certain concepts introduced in the description of methods 300, 400 above, together with a description of how different process steps illustrated in FIGS. 3 to 4g and discussed above may be implemented. Much of the following discussion refers by way of example to ML models in the form of Neural Networks (NNs). It will be appreciated that this reference to NNs is merely for the purpose of illustration, and the methods discussed herein are equally applicable to execution of ML models of different types including k-Nearest Neighbors, Support vector machines, Decision trees (such as Random forests), Naive Bayes classifier, and any other ML model having a specific memory structure.

### Continuous Training and Model Mutation

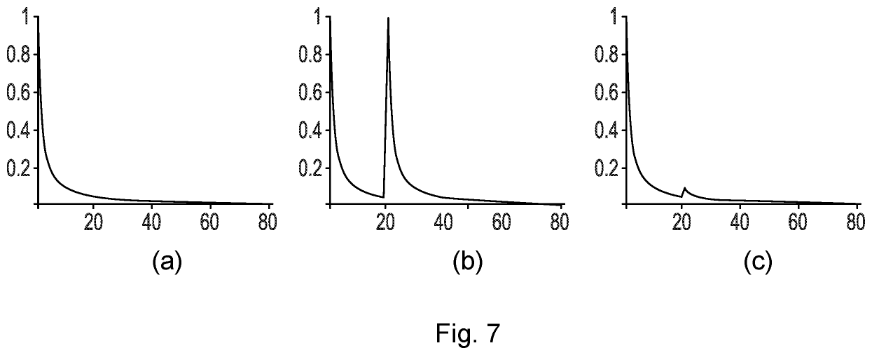

The concept of continuous training is introduced above in the context of resource nodes executing orchestration of training and deployment instances of the same ML model. Considering the example of a NN, using a set of training inputs, it is possible to train the model using a backpropagation algorithm. A commonly seen Loss-epoch curve for normal training of a NN is illustrated in FIG. 7a: the value of the loss function reduces rapidly during the first few training epochs, with further loss reduction gradually slowing until a convergence condition is reached.

It may be predicted that if the structure of a NN model is changed during the training process for the model, the Loss-epoch curve will react as if the training is starting from scratch. The Loss-epoch curve for this scenario is illustrated in FIG. 7b, with model reconfiguration taking place at epoch 20 and causing a spike in the Loss value as training is effectively restarted. If the model is used in a deployment, the model output becomes useless after epoch 20, as the model error is so high the output is effectively meaningless. The model only becomes usable again after several more training epochs are completed and the loss value returns below an acceptable threshold. In order to be able to continue using the model immediately after model reconfiguration, it would be necessary to maintain the loss value below an acceptability threshold, such that the model output remains meaningful. The Loss-epoch curve for such a scenario is illustrated in FIG. 7c. Model reconfiguration at epoch 20 does not cause the same magnitude of spike in model loss as illustrated in FIG. 7b, but rather a small increase that remains within acceptable limits for model usefulness. With the small loss increase illustrated in FIG. 7c, model outputs remain useful, meaning that training and deployment of the model may proceed simultaneously in a continuous training process. According to aspects of the present disclosure, this is achieved by introducing training and deployment instances of the same model.

In order to achieve the much smaller loss increase on model reconfiguration that is illustrated in FIG. 7c, aspects of the present disclosure introduce the concept of ML model mutation. By avoiding fundamental changes to the model, maintaining as much of the original model structure as possible, and introducing incremental model changes, it is possible to achieve a Loss-epoch curve resembling FIG. 7c, and so implement continuous training of a model while in deployment even during model reconfigurations.

Model mutation for expansion of a NN model may be achieved in the following manner. Expansion of a NN model refers to the addition of part or all of a layer or layers to the model. In order to achieve a smooth transition to the expanded model, model mutation involves selecting initial weights for the newly added layer or layers in such a way that the selected weights do not change the output of previously existing layers. In this manner, the task becomes that of solving a multi-variable equation, or if the equation is unsolvable mathematically, finding the optimum values for the weights in which the newly added layer or layers have the minimum impact on the output of the previously existing layers.

If the expansion seeks to add a full hidden layer to the model, it may be desirable to break down the new layer to many parallel sub-layers, assign each of these sub-layers to a resource node and add the resource nodes gradually to the model such that the loss value of the model never exceeds the maximum acceptable loss value for the model.

Continuous training of an NN model can be implemented as follows:

The NN model undergoes initial training via a training instance of the model. When the loss-function value for the model reaches a trigger value (maximum acceptable error), a deployment instance of the model can be instantiated and brought into production, with the training instance continuing to carry out training of the model. The model is consequently in both training and deployment at the same time. As discussed above, the training and deployment instances are separate and independent instances of the same model. The training and deployment instances thus have the same model structure executed on separate resource nodes. The only shared resource between the training and deployment instances is a single shared memory for the values of trainable parameters. Both instances may read values from this shared memory but only the training instance can write values to the memory, ensuing that the instances can execute exactly the same model but only the training instance can update the values of trainable model parameters. The training instance may additionally use a flag on the shared memory to control when the deployment instance can start using updated values of trainable parameters or implement structural changes to the model.

The training instance continues to use the same training data set to train the model, without the need for new or updated training data, and the deployment instance is used on new (real time) data for the ML task in question. If no model reconfiguration takes place, the loss function of the model will continue to decrease gradually with additional training. If the model is reconfigured, the training instance implements model mutation, meaning the loss value will experience a small temporary increase before decreasing again as the training continues. The gradual mutation means the loss function for the model always remains under an acceptable threshold, and so the deployment instance of the ML model remains functional. The speed of epoch training and its ratio to the number of ML tasks depends on the type of application and its sensitivity to the maximum loss value that is allowed.

### Resource Nodes and Functional Model Parts

Taking the example of a NN model, a complete model comprises input layer, one or more hidden layers and output layer. According to examples of the present disclosure, a complete ML model may be executed using a plurality of resource nodes, in which each resource node executes, or contains, one functional part of the complete model. For example, a single resource node may contain part of the input layer, part of hidden layer 2, 3, n, etc., or part of the output layer. Resource nodes may comprise a managing agent and one or more units of resource, including memory, computational resource, networking resource etc. Resource may be dynamic, with resource nodes acquiring and releasing resource as necessary for the execution of the functional model parts to which they are mapped. In the case of memory for example, it may be envisaged that each resource node has a limited memory capacity, with the maximum memory capacity for any given resource node defined by the granularity of functional parts of the ML model and by the largest size of mutation that the system can absorb. Each resource node executes a process to generate a placement map, mapping functional model parts to resource nodes, and consequently each resource node knows exactly which part of the full model it should execute. Examples of the present disclosure propose to use a consistent hashing process for the division of an ML model into functional model parts and the concurrent generation of the placement map. An example of such an algorithm is disclosed in WO 2020/049334, and further details may be found in the article referenced above disclosing the DataFall algorithm. By using consistent hashing in general, and DataFall in particular, examples of the present disclosure seek to guarantee a minimum amount of role exchange between resource nodes and to provide the most consistent role assignment between resource nodes.

### Example Implementation

In the following example, it is assumed that Model 1 is a NN model with 22 hidden layers and is providing endpoint protection. Model 1 is in deployment, meaning it is classifying new data, and is also in epoch #300 of continuous training, meaning it is continuously reducing its loss function value to below 0.01 and under. Model 2 is a NN model with 18 hidden layers and is providing crypto-miner detection. Model 2 is in deployment, meaning it is classifying new data, and is also in epoch #350 of continuous training, meaning it is continuously reducing its loss function value to below 0.02 and under. Models 1 and 2 are being executed by a system of resource nodes. The resource nodes have generated an initial placement map, using the DataFall algorithm, that maps functional parts of each model to a specific resource node.

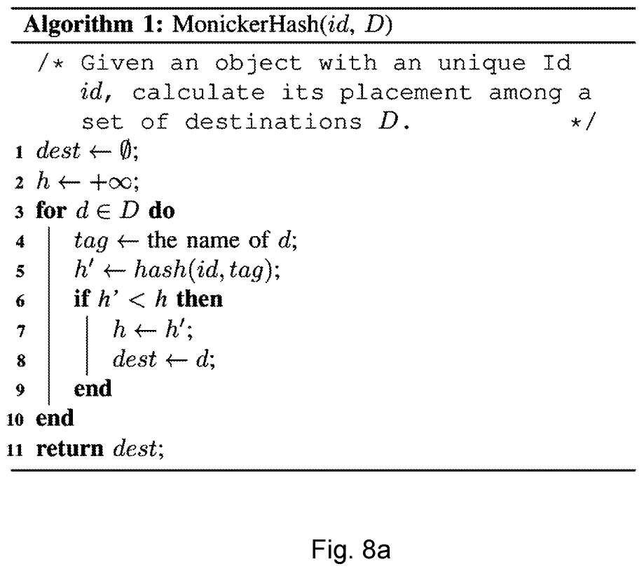

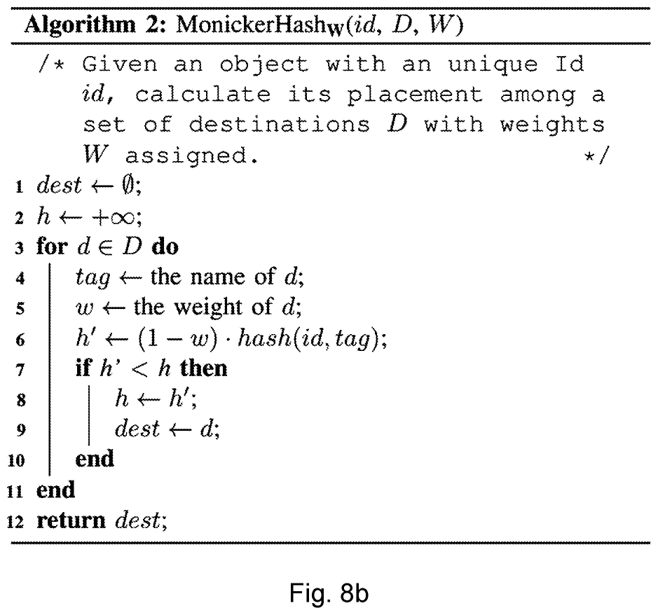

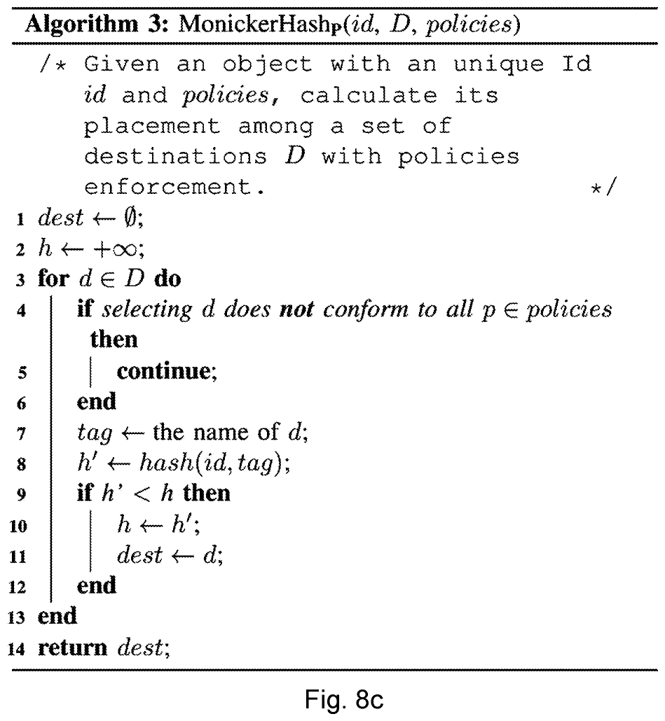

Example processes for the generation of the placement map are illustrated in FIG. 8. The examples are inspired from W. Li and F. F. Moghaddam “MonickerHash: A Decentralized Load-Balancing Algorithm for Resource/Traffic Distribution” 2019 IEEE 21st International Conference on High Performance Computing and Communications; IEEE 17th International Conference on Smart City; IEEE 5th International Conference on Data Science and Systems (HPCC/SmartCity/DSS). The resource nodes implementing Models 1 and 2 can be configured to use any of the algorithms illustrated in FIG. 8 to calculate their role (or any other resource node role) consistently. Algorithm 1 (illustrated in FIG. 8a) is the basic MonickerHash, while Algorithm 2 (illustrated in FIG. 8b) is the weighted version and Algorithm 3 (illustrated in FIG. 8c) is the policy-based version. In all the illustrated examples, the id refers to the unique id of each resource node, the set D is the set of potential and existing roles (e.g. in NN D is the set of possible layers including the input layer), tag is a unique identifier for each role (a String or and number), and dest is the selected role for the resource node (id) from the set of roles (D).

In the example scenario, an alarm is generated relating to new activities in the area of crypto-mining vulnerabilities, and this alarm is received by both models. The alarm triggers regeneration of the placement map for resource nodes, in which the crypto vulnerability alarm, by increasing the priority of Model 2, is translated into a decision to move one hidden layer from Model 1 to Model 2, meaning Model 1 will now have 21 hidden layers and Model 2 will have 19 hidden layers. Deployment of the two models continues, and an example method according to the present disclosure is used to move a hidden layer from Model 1 to Model 2 without causing the loss function of either model to exceed an acceptability threshold.

Each model is executed by a plurality of resource nodes, each resource node executing a functional model part. The hidden layer to be moved from Model 1 to Model 2 may comprise several functional parts and consequently be executed by several resource nodes. These resource nodes may be removed from Model 1 separately, one at a time, in order to avoid a significant sudden change to the model configuration which would be likely to cause the loss function to exceed the acceptability threshold. In practice, this translates to removing one resource node from the model, waiting for the resulting increase in loss function to fade and return to a suitable value for implementing an additional change, and then removing the next resource node. Removing a resource node is implemented by the resource node that is executing orchestration of the model, by ceasing to read values to and write values from the resource node that is to be removed.

A resource node that has been removed from Model 1 is aware of its new role in Model 2 via the updated placement map that all resource nodes have generated. The resource node therefore knows what functional part of Model 2 it is to execute, and can reconfigure its managed resource accordingly, if necessary. The resource node is then added to Model 2, in that the resource node orchestrating execution of Model 2 starts to write values to and read values from the new resource node. The attachment of the new resource node to Model 2 will cause an increase in the loss function of Model 2, and, as with removal of a resource node, addition of a next resource node may wait until the resulting increase in loss function has stabilized to an acceptable value. As discussed above, the weight of the new connections between the existing model and the newly added functional model part can be determined by an equation solver or an optimization solver so as to minimize impact on existing connections.

It will be appreciated that there is no one controlling entity that maintains a record of what model part is executed by which resource node, all of the resource nodes generate the same placement map and so each resource node knows its role and which model part it is to execute.

### Model Mutation of a Neural Network

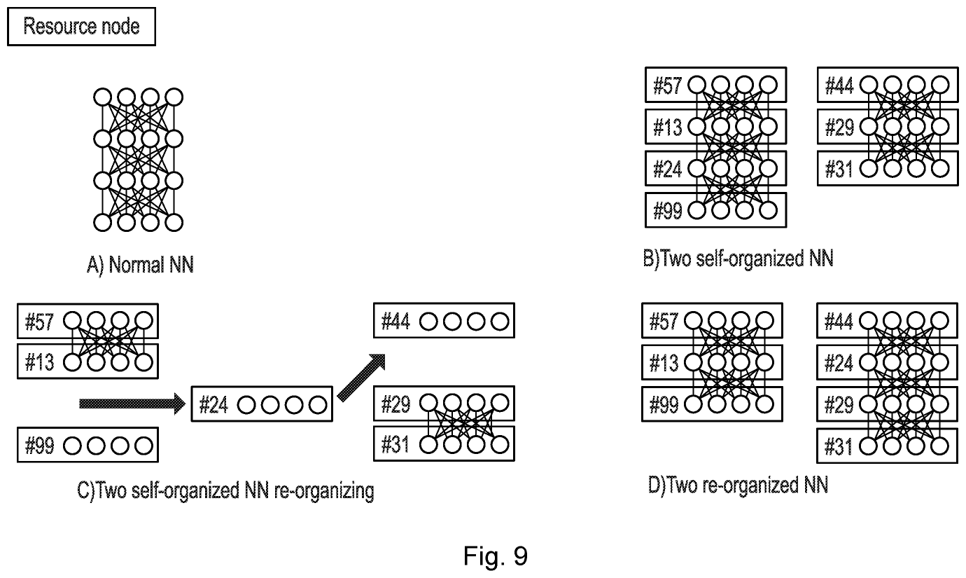

FIGS. 9a to 9d illustrate an example of how a NN may be executed using a system of resource nodes in accordance with the present disclosure. FIG. 9a illustrates a standard NN comprising four layers of neurons. FIG. 9b shows the same NN implemented by four resource nodes, with each resource node implementing one layer of neurons. FIG. 9b also illustrates a second NN comprising three resource nodes. Each resource node has a unique identifier which is illustrated in the Figure. In FIG. 8, the use of one resource node per layer is only for the sake of example; each resource node could implement part of a layer or multiple layers.

All the resource nodes use the same consistent hashing process to know which NN they belong to, and which layer of neurons they are maintaining. In each NN, the resource node that implements layer 1 executes orchestration of the model. Other resource nodes participate in the organization process and provide the layer 1 resource node with the address of memory structure of their own layer. The layer 1 resource node receives all the memory addresses of all the layers and is able to build the complete NN memory structure and use it. It will be appreciated that there is no collaboration between resource nodes to run the NN model. The NN model is run by the layer 1 resource node, and the rest of resource nodes only help with maintaining and structuring the memory and providing the layer 1 with the necessary memory addresses.

FIGS. 9c and 9d illustrate reorganization of the two NNs shown in FIG. 9b, transferring a layer from the first NN to the second NN.

Without consistent hashing, a central entity would be required to track and maintain the location and order of resource nodes. Use of a central entity is not scalable from a performance point of view if the number of NNs and layers increases. A consistent hashing technique enables self-organization of the resource nodes (layers) based on policies. This process is explained in greater detail in the article introducing the DataFall algorithm, cited above. Consistent hashing enables NNs implemented by the system of resource nodes to scale up and down their capacity based on system policies and without any intervention or tracking.

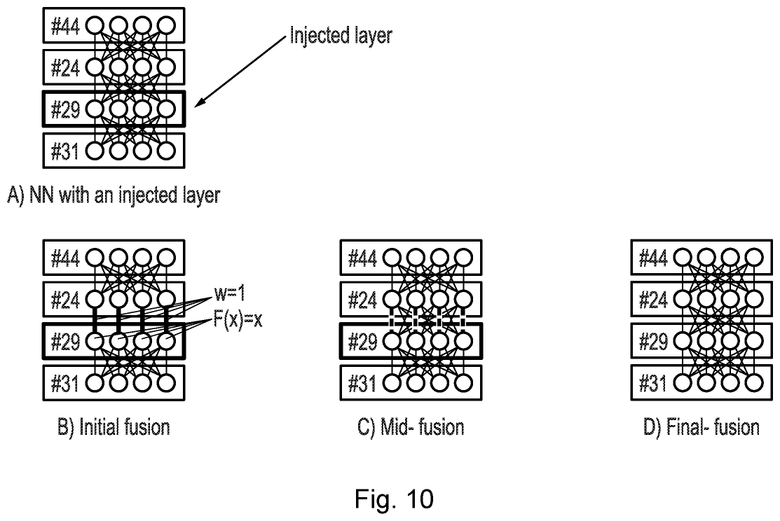

FIG. 9 illustrates in detail mutation of a NN to add a new layer. Referring initially to FIG. 10a, the new layer is executed by resource node #29, and will be the third layer of the NN in the new configuration. The goal in adding the new layer 3 is to avoid invalidating what has already been learned (i.e. the learned values of the trainable parameters) in the existing model before addition of the new layer.

As illustrated in FIG. 10b, a first step is to insert the new layer in manner that does not disturb the previous model. This involves connecting the new layer to the layer above (layer 2) with a limited connection as opposed to a full mesh, and setting the weight of each new connection to 1. In addition, the activation function of the third layer (executed by resource node #29) is set to f(x)=x which will result in bringing the results of the second layer (executed by resource node #24) to the fourth layer (executed by resource node #31) untouched. This will guarantee that even with the new layer injected the NN will still perform in the same way as before.

The next step is to gradually, in a fuzzy manner, reduce the impact of the limited connection that has a weight value w=1, and increase the impact of the full mesh with weight values that continue to be learned. This for example will lead to the situation of FIG. 10c, which is effectively 50% FIG. 10b and 50% FIG. 10d (the final version). As the relative impact of the two connection types (limited and full mesh) is changed gradually, the weights on the full mesh connection and the rest of the model will also change gradually and there will not be a large change from the weight values that were previously learned. The same gradual evolution is applied to the activation functions. For example, for the mid-point (FIG. 10c) the activation function resembles:

$$f ( x ) = \text{.5} * x + 0.5 * F ( x ) ,$$

where F(x) is the original activation function of the NN.

The above example illustrates in detail how the layers or parts of layers can be moved between two or more NN models. However, the concepts and methods discussed herein are applicable for a wide range of different ML model types, and are not limited to application in NNs. For example, in a kNN model, each resource node can execute part of the memory of the model. More resource nodes mean more information which, to some extent, can translate to more accurate results from the kNN model. In general, any AI model that has a specific memory structure can be sliced by a consistent hashing algorithm such as DataFall and can be assigned to resource nodes. It will be appreciated that transfer of resource nodes between different model types is also possible. For example, if a resource node executing a part of Model 1 which is a NN, it can easily become part of Model 2 which is a kNN model. There is nothing that is model specific about the resource nodes themselves. It is the process of generating the placement map (using a consistent hashing algorithm) that assigns the role, objective and type of ML model for a given resource node. If the type of ML model is changed from NN to kNN, the resource node may simply drop the memory that it has and create a new memory structure according to a new library.

Examples of the present disclosure can enable dynamic, seamless, and real-time restructuring of the strength of a set of deployed ML models. In the field of communication networks, multiple AI/ML security solutions to protect 5G/6G infrastructure and services are envisaged by many actors in this domain. However, the resources for running AI/ML are not limitless, and the dynamic nature of Software Defined Networks and the Network Functions Virtualisation (NVF) environment, and the unpredictable nature of zero-day attacks, generates a need for dynamic ML solutions. For example, if on a given day there is a need for more ML capacity for the protection of endpoints as a consequence of a newly revealed vulnerability in this domain, the following day the priority might be detecting crypto-currency miners, or any number of other ML tasks. Examples of the present disclosure offer a solution to enable the real-time automated transfer of resources from one ML task to another. Importantly, this transfer is facilitated without stopping either task, without manual model reconfiguration, without waiting for model retraining, and without redeploying either model.

Examples of the present disclosure can also facilitate the sharing of an ML model between parties, even when they do not use exactly the same model structure.

Aspects of the present disclosure thus introduce the concept of functional model parts and of resource nodes which may execute functional parts of an ML model. A consistent hashing process may be used by all resource nodes in a system to generate a placement map that divides a model into functional parts while also matching those functional parts to identified resource nodes. By deploying ML models using resource nodes, it is possible to implement continuous training, in which training and deployment instances of a model run in parallel. Resource node execution of ML models also enables model mutation, and combined with continuous training, this enables the seamless transfer of resources between models without having to manually reconfigure the models or pause for retraining. ML models deployed in this manner are consequently highly adaptable, with the possibility to increase or decrease the resources dedicated to a particular model on the fly, and to share models with parties using a different ML model structure without sharing the data with it, or retraining the model or requiring it to use the same model structure/size.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A computer implemented method for facilitating execution of a Machine Learning, ML, model by a system of resource nodes, wherein the ML model comprises a plurality of functional model parts, the method, performed by a resource node of the system, comprising:
generating a placement map for the ML model, wherein the placement map specifies, for each of the functional model parts, a mapping between the functional model part and at least one resource node of the system that is to execute the functional model part;
identifying, from the placement map, a functional model part that is to be executed by the resource node; and
executing the identified functional model part.

2. The method of claim 1, wherein the resource node comprises a managing agent and at least one unit of resource, the resource comprising at least one of:
storage resource;
computational resource;
networking resource.

3. The method of claim 1, further comprising:
configuring resources of the resource node for execution of the identified functional model part.

4. The method of claim 1, further comprising:
updating the placement map;
identifying, from the updated placement map, a new functional model part that is to be executed by the resource node;
ceasing to execute the previously identified functional model part; and
executing the functional model part identified from the updated placement map.

5. The method of claim 4, further comprising:
reconfiguring resource of the resource node for execution of the functional model part identified from the updated placement map.

6. The method of claim 4, wherein the method is for facilitating execution of a plurality of ML models, and wherein the functional model part identified from the updated placement map and the previously identified functional model part are functional parts of different ML models.

7. The method of claim 1, wherein:
identifying, from the placement map, a functional model part that is to be executed by the resource node comprises identifying a functional model part that orchestrates execution of the ML model; and wherein:
executing the identified functional model part comprises writing values to and reading values from other resource nodes in the system in accordance with the placement map.

8. The method of claim 1, wherein:
identifying, from the placement map, a functional model part that is to be executed by the resource node comprises identifying a functional model part that orchestrates execution of a deployment instance of the ML model; wherein:
executing the identified functional model part comprises reading values for trainable parameters of the ML model from a shared memory; and wherein:
the resource node has read only access to the shared memory, and a resource node of the system that is orchestrating execution of a training instance of the ML model has read and write access to the shared memory.

9. The method of claim 7, further comprising:
updating the placement map; and
continuing to execute the identified functional model part by writing values to and reading values from other resource nodes in the system in accordance with the updated placement map.

10. The method of claim 9, wherein the updated placement map specifies addition or removal of a functional part of the model; the method further comprising:
continuing to execute the identified functional model part by reading values for trainable parameters of the ML model from the shared memory.

11-23. (canceled)

24. A resource node of a system of resource nodes, wherein the resource node is for facilitating execution of a Machine Learning, ML, model by the system, and wherein the ML model comprises a plurality of functional model parts, the resource node comprising processing circuitry configured to cause the resource node to:
generate a placement map for the ML model, wherein the placement map specifies, for each of the functional model parts, a mapping between the functional model part and at least one resource node of the system that is to execute the functional model part;
identify, from the placement map, a functional model part that is to be executed by the resource node; and
execute the identified functional model part.

25. (canceled)

26. The resource node of claim 24, wherein the processing circuitry is further configured to cause the resource node to:
configure resources of the resource node for execution of the identified functional model part.

27. The resource node of claim 24, wherein the processing circuitry is further configured to cause the resource node to:
update the placement map;
identify, from the updated placement map, a new functional model part that is to be executed by the resource node;
cease to execute the previously identified functional model part; and
execute the functional model part identified from the updated placement map.

28. The resource node of claim 24, wherein the processing circuitry is further configured to cause the resource node to:
reconfigure resource of the resource node for execution of the functional model part identified from the updated placement map.

29. The resource node of claim 24, wherein identifying, from the placement map, a functional model part that is to be executed by the resource node comprises identifying a functional model part that orchestrates execution of the ML model; and
wherein the processing circuitry is further configured to cause the resource node to:
execute the identified functional model part comprises writing values to and reading values from other resource nodes in the system in accordance with the placement map.

30. The resource node of claim 24, wherein identifying, from the placement map, a functional model part that is to be executed by the resource node comprises identifying a functional model part that orchestrates execution of a deployment instance of the ML model; and
wherein the processing circuitry is further configured to cause the resource node to:
execute the identified functional model part comprises reading values for trainable parameters of the ML model from a shared memory; and wherein:
the resource node has read only access to the shared memory, and a resource node of the system that is orchestrating execution of a training instance of the ML model has read and write access to the shared memory.

31. The resource node of claim 24, wherein the processing circuitry is further configured to cause the resource node to:
update the placement map; and
continue to execute the identified functional model part by writing values to and reading values from other resource nodes in the system in accordance with the updated placement map.

32. The resource node of claim 31, wherein the updated placement map specifies addition or removal of a functional part of the model, and wherein the processing circuitry is further configured to cause the resource node to:
continue to execute the identified functional model part by reading values for trainable parameters of the ML model from the shared memory.
